(19) United States
(12) Patent Application Publication
(10) Pub. No.: US 2002/0134315 A1
(43) Pub. Date: Sep. 26, 2002

(54) Fragrance material

(76) Inventors: Richard M. Boden, Ocean, NJ (US); Charles E.J. Beck, Summit, NJ (US)

Correspondence Address: Joseph F. Leightner, Esq., INTERNATIONAL FLAVORS & FRAGRANCES INC., 521 West 57th Street, New York, NY, 10019, US

(21) Appl. No.: 10/104,272

(22) Filed: Mar. 20, 2002

Related U.S. Application Data
(63) Continuation-in-part of application No. 09/694,222, filed on Oct. 23, 2000, now Pat. No. 6,371,049.

(51) Int. Cl. A01K 29/00

(52) U.S. Cl. 119/171

(57) ABSTRACT

Odor-inhibiting materials comprising litter containing an odor-inhibiting quantity of western juniper. The litter materials of the present invention are advantageous in that they can be used as animal bedding and the like to mask or prevent the formation of undesirable odors in animal laboratories, pet shops, litter boxes, kennels and the like. In another application, western juniper is used to provide a pleasant odor to pesticide materials.

### RELATED APPLICATION

This application is a continuation-in-part of U.S. Ser. No. 09/694,222 filed on Oct. 23, 2000, the contents of which is incorporated by reference.

### FIELD OF THE INVENTION

The present invention relates to a novel fragrance material suitable for use in lawn and garden products.

### BACKGROUND OF THE INVENTION

Fragrances and odor masking materials have been added to areas such as bedding, litter boxes and stables and other areas where animal excreta and animal odors are to be found to mask or hopefully eliminate the odors created by such excretions. The fragrances or odor maskants have been applied to materials such as clays, sawdust, litter, and wood shavings.

One of the more popular materials used for litters is cedar, because it is a natural material which means that animals typically do not have an aversion to using a bedding material or litter containing the scent. In addition, cedar has a pleasant odor and its ability to mask undesirable odors is well known. However, cedar is a desirable species and the removal of these trees to incorporate into sawdust for bedding and litter creates an undesirable environmental impact. Cedar is also a commercially important wood specie and is therefore relatively expensive.

There is a continuing need to provide natural materials that provide a pleasant odor and has the ability to mask odors which also does not cause an undesirable environmental impact.

### SUMMARY OF THE INVENTION

The present invention provides a composition suitable for use in an animal litter product comprising an odor-inhibiting quantity of Juniperus occidentalis Hook, Cupressaceae. The common name of Juniperus occidentalis is western juniper. The present invention also includes a method of controlling odors through the addition of western juniper to litter products and in a preferred embodiment a fragrance is imparted to the western juniper to further enhance the fragrance.

A second embodiment of the present invention is the use of western juniper to provide a pleasant odor to pesticide products.

### DETAILED DESCRIPTION OF THE INVENTION

The amount of western juniper added to the litter material is effective to control odors. Odor controlling level is understood to mean that undesirable odors are reduced or substantially eliminated by the inclusion of the western juniper material. The amount of western juniper included in the litter is from about 0.01 to about 10 weight percent, preferably from 0.1 to about 8, more preferably from about 0.2 to about 5 weight percent. A highly preferred level of western juniper in the litter is about 0.4 weight percent.

Western juniper is added to a pesticide in an effective amount to provide an olfactory effect. Olfactory effect is understood to mean that undesirable odors are reduced or a pleasant odor is provided by the inclusion of the western juniper material. The present invention also provides a method for modifying an unpleasant odor, or in a more preferable embodiment providing a pleasant odor to the pesticide.

The amount of western juniper included in the pesticide product is from about 0.01 to about 10 weight percent, preferably from 0.1 to about 8, more preferably from about 0.2 to about 5 weight percent. A highly preferred level of western juniper in the pesticide product is about 0.4 weight percent.

As used in this application, pesticide is understood to mean a product that is applied to turf, crops or a specific area to kill or limit the level of insects, fungi or undesired plants. Western juniper can also be added to products such as fertilizers that are applied to stimulate plant growth or production of fruit, flowers, vegetables, and the like. Those with ordinary skill in the art will recognize that fertilizers can and often also contain active ingredients such as insecticides, miticides, and the like; as well as plant specific herbicides that kill or prevent crabgrass, dandelions, and other weeds.

The form of the western juniper that is added to the litter or pesticide product is not critical. Suitable forms include shredded, chipped and sawdust embodiments. Pesticide products are often granulated or encapsulated for longer delivery periods, safety and other considerations. If a liquid pesticide is desirable, the western juniper can be provided in a liquid form through the use of appropriate surfactants and emulsifiers to keep the particles in the liquid phase until applied.

When used in a litter, the preferred embodiment is the form most preferred by the animal using the litter. For example, since horses are stabled with straw, the western juniper would be incorporated in a larger size such as chips or shredded material. Since cats prefer small litter materials, it would be preferable that the western juniper be added to the litter in a smaller form, such as sawdust. When used with a pesticide product the western juniper can be formed to blend uniformly with the pesticide material, or if desired can be made of differing sizes so as to be visually distinct to the consumer.

Without wishing to be bound by any theory it is believed that western juniper is effective as an odor controlling agent, because the essential oil of western juniper contains (+)-Dihydromayurone, see Zhou et al., (+)-Dihydromayurone from Juniperus occidentalis, Planta Medica, 65 (1999) 680-681.

In a preferred embodiment of the invention, a second odor-controlling amount of fragrance is applied to the western juniper. The western juniper in addition to adding a pleasing scent, acts as a carrier for the second fragrance. The second fragrance is applied to the western juniper in any suitable manner, most commonly the second fragrance is sprayed onto the western juniper. The level of the second fragrance applied to the western juniper can vary widely.

The amount of fragrance admixed to western juniper is generally from about 0.5 to about 50 of the total weight of the fragrance and western juniper admixture, preferably from about 5 to about 40 weight percent, more preferably from 20 to about 35, and in a highly preferred embodiment about 25 weight percent of the total weight of the fragrance and western juniper admixture. Those with skill in the art will also recognize that the litter material itself can also contain additional fragrant materials without departing from the scope of the present invention. One advantage of the present invention is that the inclusion of the western juniper and optional fragrance does not require the remainder of the litter or bedding material to be scented. This allows less expensive materials to be employed in the bedding materials.

The amount of fragrance added to a pesticide product is generally from about 0.01 to about 10; preferably from about 0.015 to about 1 weight percent. Most preferably from about 0.02 to about 0.04 weight percent of an additional fragrance is applied to the pesticide product, preferably added to the western juniper, which acts as a carrier for the fragrance.

The second fragrance is not limited to any specific fragrance, and the fragrance can be selected on the scent desired as well as economic factors. Many types of fragrances can be employed in the present invention, limited only by the desired scent and the suitability for use with any given animal. Suitable fragrances include but are not limited to fruits such as almond, apple, cherry, grape, pear, pineapple, orange, strawberry, raspberry; musk, flower scents such as lavender-like, rose-like, iris-like, and carnation-like. Other pleasant scents include herbal and woodland scents derived from pine, spruce and other forest smells. Fragrances may also be derived from various oils, such as essential oils, or from plant materials such as peppermint, spearmint and the like. Other familiar and popular smells can also be employed, such as baby powder, popcorn, pizza, cotton candy and the like, in the present invention. Preferably the second fragrance is a woody scent which will compliment the natural fragrance of the western juniper.

A list of suitable fragrances is provided in U.S. Pat. No. 4,534,891, the contents of which are hereby incorporated by reference. Another source of suitable fragrances is found in Perfumes Cosmetics and Soaps, Second Edition, edited by W. A. Poucher, 1959. Among the fragrances provided in this treatise are acacia, cassie, chypre, cyclamen, fern, gardenia, hawthorn, heliotrope, honeysuckle, hyacinth, jasmin, lilac, lily, magnolia, mimosa, narcissus, freshly-cut hay, orange blossom, orchids, reseda, sweet pea, trefle, tuberose, vanilla, violet, wallflower, and the like.

In addition to the fragrance other agents can be used in conjunction with the fragrance. Well known materials such as surfactants, emulsifiers, polymers to encapsulate the fragrance can also be employed without departing from the scope of the present invention.

As used herein litter is understood to include any material used as bedding or waste retaining material for pets, livestock or other animals. Suitable materials include without limitation clays, wood chips, sawdust, shredded polymers, such as polyurethane, polyethylene, straw, clumping materials as described in U.S. Pat. Nos. 5,806,462, 5,458,091, 5,452,684, 5,469,809, 5,193,489, 5,101,771 and 5,000,115, the patents herein incorporated by reference as set forth in their entirety. The present invention also contemplates mixtures of the bedding or waste retaining materials in combination with the western juniper materials. The litter products of this invention can be used to inhibit, mask or eliminate animal odors found in environments such as cages, pens, enclosures, bedding, stables and areas where animals such as rats, mice, hamsters, guinea pigs, rabbits, squirrels, monkeys, horses, dogs, cats, raccoons, chickens and other birds are housed or enclosed.

One advantage of using western juniper is that it is considered a nuisance plant or a weed and it is commonly removed from areas to provide room for more desirable plants. Since it grows quickly and it is considered a weed, western juniper is inexpensive to obtain and can be easily obtained.

The compositions of the invention are relatively non-toxic to man and animals in the amounts that are added to the litter materials. In addition, Juniperus occidentalis has been reported to have acaricidal activity against Ixodes scapularis which has been linked to Lyme disease, see Zhou et al., (+)-Dihydromayuronefrom Juniperus occidentalis, Planta Medica, 65 (1999) 680-681. This additional biological activity is also believed to provide antibacterial properties that are also helpful in reducing undesirable odors.

These and additional modifications and improvements of the present invention may also be apparent to those with ordinary skill in the art. The particular combinations of element described and illustrated herein are intended only to represent only a certain embodiment of the present invention and is not intended to serve as limitations of alternative articles with the spirit and scope of the invention.

### EXAMPLE 1

Various commercially available non-fragranced cat litters were purchased and three commercially available fragrances (available from International Flavors and Fragrances Inc.) were tested. The commercially available non-fragranced litters tested were TIDY CAT CRYSTALS, TIDY CAT MULTI CAT (long lasting) and TIDY CAT MULTI-CAT litters, available from the Ralston-Purina Company; FRESH STEP available from the Clorox Company and SUPER STOP available from Church & Dwight.

The three fragrances were added to the western juniper shavings at a level of 25 weight percent. The fragrance and western juniper admixture was added to the non-fragranced cat litter at a level of 0.4 weight percent. In addition, the same level of fragrance was added to the commercially available litters as was added to the western juniper.

The evaluation procedure was as follows: 50 grams of cat litter, both the commercially available unscented materials, the cat litter and the fragrance and those containing the western juniper and fragrance, were added to four ounce jars. One-half milliliter of cat urine was added to the jars and the jars were capped. Odors were allowed to accumulate in the headspace of the jars over one, two and three hours. The jars were opened and sampled for urine smell.

The samples that contained the mixture of fragrance and western juniper shavings performed much better than any of the commercially available litters, even those that contained fragrance. The litter containing the fragrance and western juniper shavings had little or no objectionable odor and in some instances a pleasant odor was still detected.

### EXAMPLE 2

A suitable fragrance for use with a pesticide product is provided below. The fragrance was developed to be incorporated with the western juniper at the levels set forth in the specification above.

| Name | Weight |
|---|---|
| Amyl Cinnamic Aldehyde | 2 |
| Amyl Salicylate | 10 |
| Aubepine | 2.5 |
| Benzyl Acetate | 12.5 |
| Bergamot Oil | 22 |
| Caraway Oil | 0.4 |
| Cedarwood Oil | 1 |
| Citronella Oil | 2.5 |
| Civet 10% DPG | 0.8 |
| Dimethyl Hydroquinone | 0.2 |
| GALAXOLIDE 50% DPG (IFF) | 16.8 |
| Geranium | 3.8 |
| HEDIONE (Firmenich) | 2 |
| Heliotropine | 3.4 |
| Indolarome 10% DPG | 0.4 |
| ISO E SUPER (IFF) | 2 |
| Lavandin Grosso | 4 |
| Linalyl Acetate | 1 |
| Methyl Salicylate | 1 |
| Patchouli Oil Light | 1 |
| Phenyl Ethyl Alcohol | 2 |
| Spearmint Oil | 1 |
| Tangerine Oil | 1 |
| Terpinyl Acetate | 1.3 |
| Vanillin | 3.6 |
| VERAMOSS (IFF) | 0.8 |
| Vertofix Coeur | 1 |
| TOTAL | 100 |

As used in the chart above, the following initials and suppliers are understood to mean the following:

DPG is dipropylene glycol;

IFF is International Flavors & Fragrances Inc., Hazlet, N.J.; and

Firmenich is Firmenich Incorporated, Plainsboro, N.J. 08536.

Unless noted to the contrary all of the fragrance materials provided above are available from International Flavors & Fragrances Inc., Hazlet, N.J. 07730.

All percentages are by weight unless noted to the contrary.

What is claimed is:

1. An animal litter product comprising a bedding material and an odor-inhibiting quantity of western juniper.

2. The animal litter product of claim 1 wherein the bedding material is selected from the group consisting of clays, wood chips, sawdust, straw, clumping materials, shredded polymers and mixtures thereof.

3. The animal litter product of claim 1 wherein the odor inhibiting quantity of western juniper is from about 0.1 to about 10 weight percent of the animal litter product.

4. The animal litter product of claim 1 wherein the odor-inhibiting quantity of western juniper additionally contains a second fragrance.

5. The animal litter product of claim 1 wherein the odor inhibiting quantity of western juniper is from about 0.2 to about 5 weight percent of the animal litter product.

6. The animal litter product of claim 1 wherein the odor inhibiting quantity of western juniper is from about 0.4 weight percent of the animal litter product.

7. The animal litter product of claim 4 wherein the second fragrance is added at a level of from about 15 to about 50 weight percent based upon the weight of the western juniper.

8. A process for inhibiting odors in animal bedding which comprises applying to the bedding material an effective amount of western juniper.

9. The process of claim 8 wherein the effective amount of western juniper is from about 0.1 to about 10 weight percent of the animal litter product.

10. The process of claim 9 wherein the second fragrance is added at a level of from about 0.1 to about 50 weight percent based upon the weight of the western juniper and second fragrance.

11. A pesticide containing an olfactory effective amount of western juniper.

12. The pesticide of claim 11 which is applied to a crop, lawn or garden.

13. The pesticide product of claim 12 which contains from about 0.5 to about 15 weight percent western juniper.

14. The pesticide of claim 13 which contains from about 8 to about 12 weight percent western juniper.

15. The pesticide of claim 11 which contains a fragrance.

16. The pesticide of claim 15 wherein the fragrance is provided on the western juniper.

17. A method for modifying or enhancing the odor of a pesticide product which comprises adding an olfactory effective amount of western juniper.

18. The method of claim 17 wherein the effective amount is from about 5 to about 15 weight percent western juniper.

19. The method of claim 18 wherein the effective amount is from about 8 to about 12 weight percent western juniper.

20. The method of claim 17 which contains a fragrance.

21. A fertilizer containing an olfactory effective amount of western juniper.

22. The fertilizer of claim 21 which is applied to a crop, lawn or garden.

23. The fertilizer product of claim 22 which contains from about 0.5 to about 15 weight percent western juniper.

24. The fertilizer of claim 23 which contains from about 8 to about 12 weight percent western juniper.

25. The fertilizer of claim 21 which contains a fragrance.

26. The fertilizer of claim 25 wherein the fragrance is provided on the western juniper.

27. A method for modifying or enhancing the odor of a fertilizer product which comprises adding an olfactory effective amount of western juniper.

28. The method of claim 27 wherein the effective amount is from about 5 to about 15 weight percent western juniper.

29. The method of claim 28 wherein the effective amount is from about 8 to about 12 weight percent western juniper.

30. The method of claim 27 which contains a fragrance.
